(19) United States
(12) Patent Application Publication
(10) Pub. No.: US 2011/0174896 A1
(43) Pub. Date: Jul. 21, 2011

(54) FOUNTAIN FOR FLUID

(75) Inventors: Justin Posner, Radlett (GB); Darren Giles, Surrey (GB)

(73) Assignee: Giles & Posner Ltd., Watford (GB)

(21) Appl. No.: 12/863,738

(22) PCT Filed: Jan. 26, 2009
(86) PCT No.: PCT/GB2009/000220

§ 371 Date: Oct. 25, 2010

(30) Foreign Application Priority Data
Jan. 25, 2008 (GB) 0801438.3

(51) Int. Cl. A23G 3/20; A23G 1/04

(52) U.S. Cl. 239/17

(57) ABSTRACT

A fountain for liquid chocolate, comprising: a heated bowl, at least two parallel adjacent open cylinders extending normally of the bowl from a fluid intake position near the bottom of the bowl to a fluid outlet position remote from the bowl, each cylinder containing a coextensive auger whose spiral flight has a rim engaging an inner cylindrical surface of the cylinder and the auger being mounted for rotation about the axis of the cylinder, means for rotating the augers to cause fluid entering the cylinders from the bowl to be conveyed axially to the fluid outlets, and a partition extending across the bowl to prevent mixture of fluid in different portions of the bowl, the arrangement being such that, when the fountain is orientated in use with the cylinders vertical, fluid falling from the top of each cylinder reaches only the respective portion of the bowl from which it was taken.

This invention relates to a fountain for fluid, and is particularly useful for dispensing a viscous fluid such as liquid chocolate.

Chocolate fountains are well known, for example from GB-A-2421056 the contents of which are incorporated by reference herein. Heated chocolate is caused to circulate in a fountain which may have several tiers, and chocolate may be dispensed from the tiers for example by dipping fruit into the molten chocolate. The falling of liquid chocolate from tier to tier also makes an attractive display.

Chocolate fountains may be used domestically, but there is also a large market for the rental of such machines, especially larger installations for commercial use. Both domestic and commercial types of chocolate fountain rely for their success on attracting the end user and there is always a need for improvement in the attractiveness of the fountain in use.

Accordingly, the present invention provides a fountain for liquid chocolate, comprising a heated bowl, at least two parallel adjacent open cylinders extending normally of the bowl from a fluid intake position near the bottom of the bowl to a fluid outlet position remote from the bowl, each cylinder containing a coextensive auger whose spiral flight has a rim engaging an inner cylindrical surface of the cylinder and the auger being mounted for rotation about the axis of the cylinder, means for rotating the augers to cause fluid entering the cylinders from the bowl to be conveyed axially to the fluid outlets, and a partition extending across the bowl to prevent mixture of fluid in different portions of the bowl, the arrangement being such that, when the fountain is orientated in use with the cylinders vertical, fluid falling from the top of each cylinder reaches only the respective portion of the bowl from which it was taken.

By dividing the fluid between two or more different cylinders and their respective containers for the fluid such as liquid chocolate, the invention allows a fountain to be used with one or two different types of chocolate, without any mixture occurring. It may for example be used for plain and white chocolate, milk and plain chocolate or milk and white chocolate. Each type of chocolate can form its own separate part of the cascade in the fountain, and this increases the visual appeal of the fountain as well as making it possible to dispense the different types of chocolate from the same place. Fruit, for example, can be dipped into successive parts of the fountain to build up coatings of different chocolates.

In order that the invention may be better understood, a preferred embodiment will now be described, by way of example only, with reference to the accompanying drawings, in which:

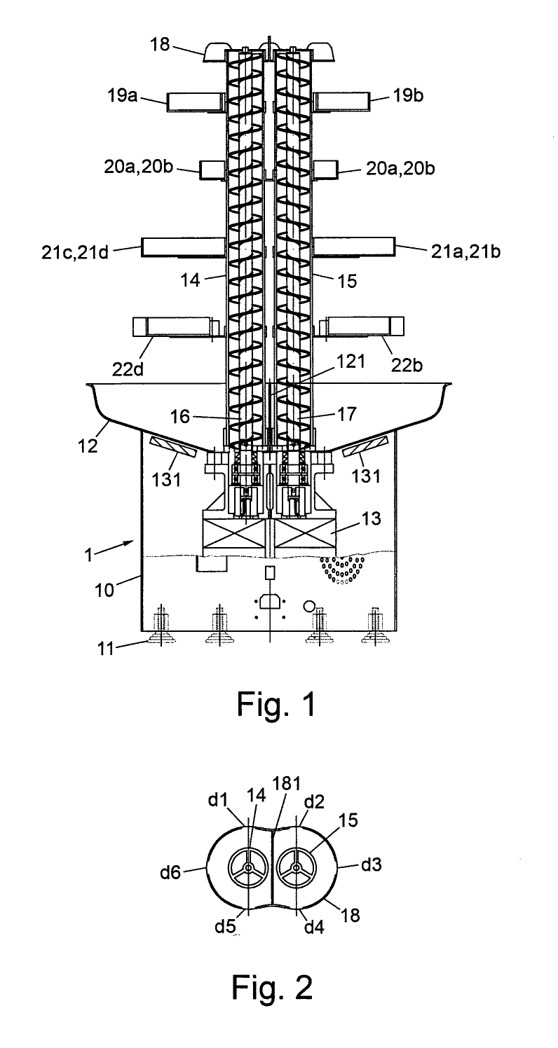

FIG. 1 is an axial cross section in a vertical plane through a chocolate fountain embodying the invention;

and FIGS. 2 to 6 are cross sections taken in horizontal planes through different tiers of the chocolate fountain of FIG. 1.

A chocolate fountain 1 embodying the invention, as shown in FIG. 1, has a base unit 10 mounted on four feet 11 and housing an electric motor 13 whose output spindle drives gearing coupled rotationally to a pair of parallel, vertically mounted augers 16, 17. Each auger has a spiral flight with a rim which engages the inner cylindrical surface of a respective cylinder 14, 15 which has open ends at the top and the bottom. Each cylinder is mounted removably, for example by a screw-threaded engagement, in a respective portion of the base unit 10 integral with the motor 13.

A bowl 12, which is circular in plan view, is integrally mounted on the base unit 10, and is thermally connected to an annular electric heater 131, for example, a silicone rubber matt heater which may be attached (e.g. stuck) to the underside of the bowl, for evenly heating the contents of the bowl. A major portion of the bowl is frusto-conical so as to provide a sloping surface for causing the fluid contents to flow towards the axial centre of the bowl. The bottom of the bowl is annular and is perpendicular to the axes of the cylinders 14, 15. In use, the cylinders are vertical and the bowl horizontal.

The lower ends of the cylinders 14, 15 are positioned close to the bottom of the bowl, but with a gap of around 5 to 10 mm to allow molten chocolate to enter the cylinders from below. The base of each auger 16, 17 is positioned so as to scoop up the fluid entering at this point, and the auger then lifts the fluid to a fluid outlet at the top of the cylinder, when it is rotated by the motor 13.

In this example, there are five tiers of trays for the fluid to pass through once it has left the top of the cylinders. The fluid falls from the rim of each successive tier into the tier below, and eventually back into the bowl 12 for reheating and recirculation up the respective cylinder.

In this example, there are two separate fluid flow systems, one on the left hand side and one on the right hand side of FIG. 1. By ensuring that fluid cannot flow between these systems, there is no mixture between the fluids, which may, for example be white chocolate and milk chocolate.

The bowl 12 itself is divided into two equal portions by a central wall 121 extending diametrically across the bowl and normal to the bottom of the bowl. The wall 121 is between the two cylinders.

The top tier 18 is supported by the top ends of the two cylinders 14, 15 which it surrounds.

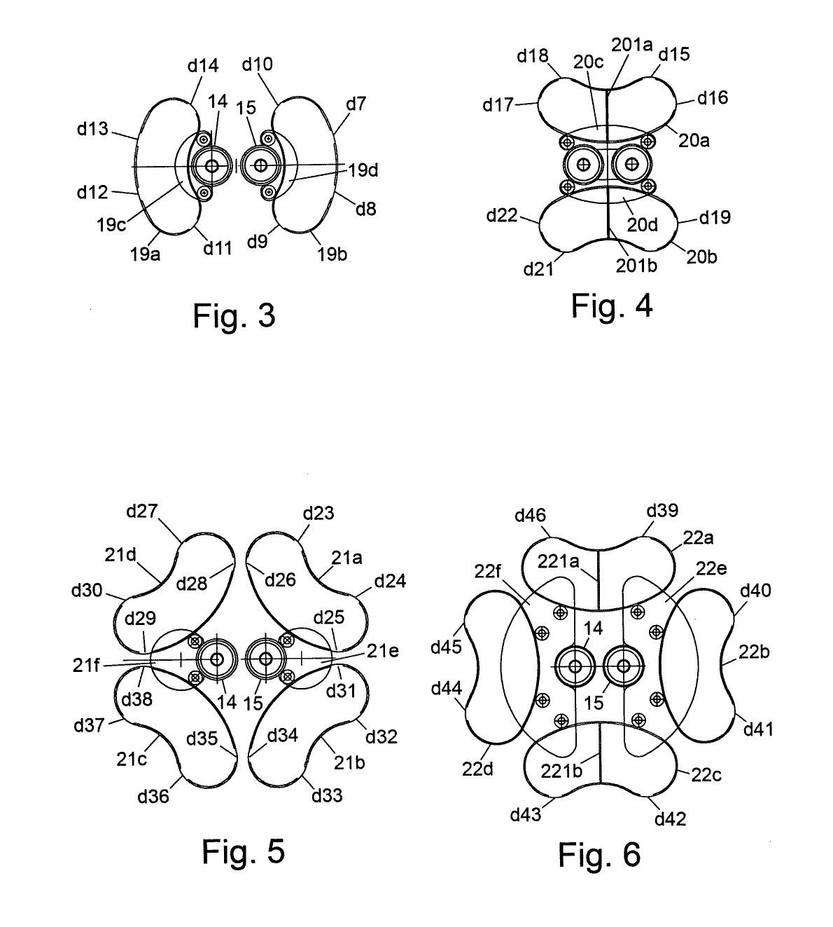

The top tier 18 comprises a single tray divided into two equal portions by a centre partition 181 extending between the cylinders across the tray. Each portion of the tray has a top rim at the same vertical level, and this rim is formed with depressions approximately 10 to 15 mm wide and some 2 to 5 mm deep which guide the fluid out of the tray. The right hand portion of the tray 18 has depressions d2, d3 and d4, whilst the left hand portion has depressions d1, d5 and d6. These cause a symmetric display with six separate cascades from the top tier 18 down to a top intermediate tier consisting of two separate trays 19a and 19b as shown in FIG. 3. These trays are kidney-shaped and are positioned to collect the cascades falling from the top tier 18.

A top intermediate tier, known as stage 1, and shown in FIG. 3, is supported by ledges extending transversely from the exterior surfaces of the cylinders, as shown. These ledges 19c and 19d are formed integrally with the cylinders. The trays of this tier are removable for cleaning as are all the trays of the fountain.

The right hand tray 19b has four depressions d7, d8, d9 and d10 around its rim. Correspondingly, there are four depressions d11, d12, d13 and d14 around the rim of the left hand tray 19a.

Fluid falling in cascades from stage 1 is collected in a further intermediate tier, known as stage 2. At stage 2, as shown in FIG. 4, there are two trays 20a and 20b mounted on ledges 20c and 20d respectively. The back tray 20a is divided by a central partition 201a into two equal portions; correspondingly, the front tray 20b is divided by a central partition 201b into two equal portions. There are thus four different reservoirs for the fluid at stage 2, the right hand ones of which collect fluid falling from the right hand tier 19b of stage 1. Correspondingly, the left hand portions collect the fluid falling from the left hand tray 19a.

The back tray 20a has depressions d15 and d16 in the right hand portion, and depressions d17 and 18d in the left hand portion. Correspondingly, the front tray 20b has depressions d19 and d20 in the right hand portion and d21 and d22 in the left hand portion.

The trays 20a and 20b are also kidney-shaped, but are concave to the outside, in contrast to the kidney-shaped trays 19a and 19b of the stage 1 tier which are convex to the outside. This arrangement facilitates the collection of the fluid reliably from the tier above. Alternating between convex and concave arrangements, from tier to tier, also contributes to the aesthetic quality of the fountain as a whole. Further, the effective rotation, by a quarter of a turn, of the pairs of trays going from stage 1 to stage 2 enhances the visual appeal of the fountain arrangement.

The next lower tier is shown in FIG. 5, and this is known as stage 3. This comprises four trays 21a, 21b, 21c and 21d, each one being kidney-shaped and concave to the exterior. The right hand pair of trays rests on a ledge 21e, and the left hand pair of trays rests on a ledge 21f. The back right hand tray 21a collects fluid falling from the back right hand portion of tray 20a; and tray 21a has four depressions d23, d24, d25 and d26 in its rim. The other three trays 21b, 21c and 21d correspondingly collect the fluid from respective portions of stage 2, and each of them has four depressions d31 to d34, d35 to d38 and d27 to d30. At stage 3, none of the trays has a partition.

The next lower tier, known as stage 4, is shown in FIG. 6, and consists of four kidney-shaped trays 22a, 22b, 22c and 22d arranged on ledges 22e and 22f. These trays are concave from the exterior, and each tray collects fluid falling from two of the trays of stage 3. In order to maintain the partitioning between the two fluid systems, the rear tray 22a has a central partition 221a, and the front tray 22c has a central partition 221b, so as to create four portions of equal size. Each tray has two depressions in its rim. Fluid falling from depressions d39, d40, d41 and d42 falls into the right hand portion of the bowl 12, whereas fluid falling from depressions d43, d44, d45 and d46 falls into the left hand portion.

In this example, the diameter of the base unit 10 is about 370 mm, the height of the rim of the bowl 12 being about 360 mm above the underside of the base unit. The diameter of the bowl 12 is about 525 mm.

The undersides of the trays 22a-22d, 21a-21d, 20a and 20b, 19a and 19b, and 18 are respectively about 69 mm, 185 mm, 297 mm, 397 mm and 470 mm above the rim of the bowl 12

In this example, the vertical separation between the tiers is substantially equal, and corresponds to the maximum distance of fall for which chocolate would not splash over the side of the trays. The trays of each tier are coplanar, although this is not essential.

The use of the chocolate fountain is conventional except for the way in which it is partitioned into two fluid systems and for the plural cylinders. Thus chocolate in solid form is placed into bowl 12, is heated by the heater 131, and is then drawn to the top of the cylinders by rotation of the augers, to fall through the depressions in cascades/streams down successive tiers, for recirculation from the bowl. Since the fluid chocolate falls in streams from one tier to the tier below, the stream of fluid is directed so as not to mix with fluid chocolate of a different type, which may occur with prior art fountains where different flows are in curtains rather than in streams. Cleaning of the fountain may be undertaken by removal of the tiers from the cylinders and removal of the cylinders from the bowl and the bowl from the base unit 10, allowing each component including the bowl to be cleaned independently and thoroughly.

The invention is not limited to the particular example shown in the drawings. There may for example be three or even more cylinders each with its own auger, and with a corresponding number of independent fluid systems for re-circulating different types of fluid. In the case of three or more systems, the tiers would each be divided angularly, when viewed from above. There would generally have to be more trays or more portions of trays, to allow for the independent movement of each fluid through the re-circulating system. Although one motor has been described, there could clearly be multiple motors.

Instead of the ledges, other supporting means for the tiers may be substituted such as three wielded stops, the trays being connected by arms or by a frame. A frame could interconnect some or all of the trays, and could be supported by the base unit 10.

The fountain described above and as shown in the Figures has depressions in the rim of each tray. In other embodiments some, but not all of the trays may have depressions.

1. A fountain for liquid chocolate, comprising:
a heated bowl, at least two parallel adjacent open cylinders extending normally of the bowl from a fluid intake position near the bottom of the bowl to a fluid outlet position remote from the bowl, each cylinder containing a coextensive auger whose spiral flight has a rim engaging an inner cylindrical surface of the cylinder and the auger being mounted for rotation about the axis of the cylinder, means for rotating the augers to cause fluid entering the cylinders from the bowl to be conveyed axially to the fluid outlets, a partition extending across the bowl to prevent mixture of fluid in different portions of the bowl, and at least one tier assembly arranged to be mounted around the cylinders remote from the bowl, the tier assembly having a tray, or a portion of a divided tray, for each respective cylinder, the trays having depressions in their upper lips to collect fluid originating from the fluid outlet of that cylinder and to direct the flow of fluid from the tray through those depressions to be collected in a lower respective tray or the respective portion of the bowl, the arrangement being such that, when the fountain is orientated in use with the cylinders vertical, fluid falling from the top of each cylinder reaches only the respective portion of the bowl from which it was taken.

2. (canceled)

3. A fountain according to claim 1, in which there are at least two such tier assemblies, thereby forming a cascade from one tier assembly to the next and then to the bowl.

4. A fountain according to claim 3, in which one tier assembly is arranged to be mounted at the fluid outlet, and is a single tray divided into portions equal in number to the cylinders.

5. A fountain according to claim 4, in which there is at least one intermediate tier assembly arranged to be mounted between the fluid outlet and the bowl, comprising separated trays equal in number to the cylinders.

6. A fountain according to claim 5, in which there are at least two such intermediate tier assemblies, of which the one closer to the bowl has more trays than the number of cylinders, two or more of which trays are positioned in use to collect fluid from only one tray of the next tier furthest from the bowl.

7. A fountain according to claim 6, in which the trays of intermediate tier assemblies are substantially kidney-shaped.

8. A fountain according to claim 6, in which there are two cylinders and four intermediate tier assemblies of which the two furthest from the bowl have two trays each and the two nearest the bowl have four trays each.

9. A fountain according to claim 1, comprising means for supporting the trays removably around the cylinders.

10. (canceled)

11. A fountain according to claim 1, comprising an electric heater thermally connected to the bowl.

12. A fountain according to claim 1, in which the rotating means comprises two electric motors whose drive spindles are coupled to the augers.

13. (canceled)
